(19) United States
(12) Patent Application Publication
(10) Pub. No.: US 2018/0225731 A1
(43) Pub. Date: Aug. 9, 2018

(54) INTEGRATED VIRTUAL SHOPPING

(71) Applicant: SAP SE, Walldorf (DE)

(72) Inventor: Juergen Gatter, Rauenberg (DE)

(21) Appl. No.: 15/424,026

(22) Filed: Feb. 3, 2017

(51) Int. Cl. G06Q 30/06; G06T 19/00

(52) U.S. Cl. CPC G06Q 30/0601; G06T 19/00

(57) ABSTRACT

Methods, systems, and computer program products for shopping are described. An entry of a user into a physical establishment is detected and information corresponding to a virtual activity of the user in a virtual shopping environment is retrieved. The information is provided to a client device corresponding to the physical establishment.

### FIELD

The present disclosure relates generally to virtual shopping. In an example embodiment, the disclosure relates to integrating brick-and-mortar and online shopping.

### BACKGROUND

Shoppers often shop for items in a variety of markets, such as brick-and-mortar (BAM) establishments and online shops. While shoppers often purchase an item in only one of these shopping environments, they are increasingly visiting both environments to evaluate items for sale, compare prices, make purchases, and the like. For shoppers who visit an online shop or both shopping environments, the shopping may lack the familiar and comprehensive experience achieved by shopping with the same clerk, at the same establishment, in the same location.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example processing system for providing a shopping environment, in accordance with an example embodiment;

FIG. 2 is a block diagram of an example apparatus for implementing a BAM server, in accordance with an example embodiment;

FIG. 3 is a block diagram of an example apparatus for implementing a virtual environment server, in accordance with an example embodiment;

FIG. 4A is a table for an example user profile, according to an example embodiment;

FIG. 4B is a table for an example shopping history of a user, according to an example embodiment;

FIG. 4C is a table for example privacy settings of a user, according to an example embodiment;

FIG. 4D is an example table for maintaining a state of user shopping activities, according to an example embodiment;

FIG. 5 is a flowchart for an example method for processing a user entry into a BAM establishment, according to an example embodiment;

FIGS. 6A and 6B are a flowchart for an example method for processing a user entry into a virtual mall or virtual store, according to an example embodiment;

FIG. 7 is a flowchart for an example method for generating audio for a user in the virtual environment, according to an example embodiment;

FIG. 8 is a block diagram illustrating a mobile device, according to an example embodiment; and

FIG. 9 is a block diagram of a computer processing system within which a set of instructions may be executed for causing a computer to perform any one or more of the methodologies discussed herein.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

Generally, methods, systems, apparatus, and computer program products are described for facilitating shopping online and at brick-and-mortar establishments. In one example embodiment, a user's shopping experience online and shopping experience in a brick-and-mortar establishment are integrated to provide a unified, comprehensive shopping experience. Moreover, the individual online and brick-and-mortar shopping experiences are enhanced with a variety of communication modalities, shopper tracking, cross-environment shopping assistance, and the like.

In one example embodiment, a central physical establishment, called an “anchor”, provides a portal to the user's locality, such as a city, town, and the like. An independent instance of a shopping mall operator bundles activities and invests in future technologies for the anchor and its associated shops. In one example embodiment, search-focused user interface technologies are replaced or augmented by a centric virtual shopping experience presented in a three-dimensional manner. Virtual life is generated by enabling multiple shoppers, friends, users, and the like to simultaneously enter a virtual mall, virtual shops, and the like. As described more fully below, users in the shopping mall are visualized by three-dimensional avatars and a tight integration of real shop employees and a virtual shop is accomplished by interaction with and support provided by avatars representing the real shop employees.

The hallways of the virtual mall are not empty; there are other shopper's avatars walking around and there is advertising on the walls. A virtual personal assistant may accompany a user browsing through the virtual mall, answering questions submitted by the user and providing search functionality to the user, as described more fully below. Various processes, such as logistics, payment, assistance, and the like, may be bundled and then visualized using the avatars. Virtual events, such as presentations, flea markets, question and answer sessions, and the like, are integrated into the virtual environment to further evolve a user's virtual life. In one example embodiment, clothes advertised in a virtual shop may be projected onto a user's personal avatar and may be viewed in a three-dimensional mirror. In one example embodiment, a flea market allows users to sell items. The items may be housed in the anchor building, which may use warehouse software to temporarily add them to their own inventory. The user remains responsible for the presentation of the items in a virtual, two-dimensional flea market.

In one example embodiment, a user's entry into a brick-and-mortar establishment (also known as a physical establishment or physical store herein) is detected by a shopping system and information associated with the user is retrieved. The user's entry may be detected, for example, by scanning for an RFID tag carried by the user, by performing face recognition on an image of the store's entry point, and the like. The information retrieved may include a user's profile, a user's privacy settings, a user's shopping history, a customer value level, and the like. (The customer value level indicates the importance of the identified user to the merchant's business.) If the user has conducted online activity, the state of the activity (such as the identity of the items viewed online, the state of in-progress or completed transactions, requests for assistance, and the like) may also be retrieved. In one example embodiment, the online information is only retrieved if the online activity is associated with the brick-and-mortar store that the user entered. For example, the online information may only be retrieved if the brick-and-mortar store that the user entered is in a mall associated with the online activity, if the brick-and-mortar store that the user entered has the same store name as the online store, if the brick-and-mortar store is designated as being associated with the online store, and the like.

Similarly, logging into online shopping or entry by an avatar (representing a user) into a virtual mall or virtual store may be detected by a shopping system, and information associated with the user may be retrieved. For example, a user's profile, a user's privacy settings, a user's shopping history, a customer value level, and the like may be obtained.

In one example embodiment, the virtual mall appears to the user as a three-dimensional shopping mall or city landscape. Hallways, streets, and the like allow avatars representing the users to travel by and enter virtual stores that line the hallways, corridors, and streets. Advertisements or other marketing material may be displayed on the walls of buildings, corridors, stores, and the like, where they are visible to users whose avatars are in the vicinity of the marketing material. An avatar of a user may be accompanied by the avatars representing other users, such as friends of the user, personal assistants, and the like. The personal assistant may correspond to a human being or to a computer-generated concierge. Products in the shops may be presented on three-dimensional shelves.

If the user has conducted activity in a brick-and-mortar store, the state of the activity (such as the identity of the items viewed, the state of in-progress or completed transactions, contacts with a store clerk, time of visits, and the like) may also be retrieved. In one example embodiment, the information associated with the brick-and-mortar store is only retrieved if the activity is associated with the virtual store or virtual mall that the user has logged into.

A user's privacy settings may control a variety of functions in the shopping system. For example, detection of the user's entry into a store may be suppressed if the user requests privacy in this regard. In one example embodiment, the user's privacy setting determines an amount of automatic service and assistance that is provided to the user. For example, a privacy setting may indicate that a clerk may only approach the user if requested by the user, that only a particular clerk may approach the user, that a greeting or other message should or should not be sent to the user (unless the user has requested assistance), and the like. The privacy settings may also determine what information, if any, is transferred from the virtual (online) environment to the brick-and-mortar environment, or from the brick-and-mortar environment to the virtual (online) environment.

In one example embodiment, a user in the virtual environment can obtain the assistance of a clerk. The clerk may be a virtual clerk or a store clerk. A virtual clerk is a computer-generated clerk that may greet a user, answer user questions, accompanying the user while the user browses the virtual environment, and the like. The virtual clerk may be represented by an avatar in the virtual environment; a user may find a virtual clerk at a virtual desk in the virtual mall or store, roaming through the virtual environment, and the like. A user may summon a virtual clerk or store clerk by clicking on an avatar or other icon representing the virtual clerk, store clerk, and the like.

The store clerk is a human being who may be represented by an avatar in the virtual environment. The store clerk may be a clerk working in a brick-and-mortar store associated with the virtual environment. The availability of a store clerk to assist a user in the virtual environment can be indicated by the avatar of the store clerk. For example, if the store clerk is unavailable, the avatar representing the store clerk can be illustrated as being busy conversing with another avatar, being busy at a counter, being busy in a store room, and the like. If the store clerk is available, the avatar representing the store clerk can be illustrated as walking around the virtual store, as being located by a help desk or point-of-sale counter, and the like. If the store clerk is ready to assist the user, the store clerk can, for example, enable a microphone and headphones that provide connectivity to the virtual environment. In response to the store clerk enabling the microphone and headphones, the avatar representing the store clerk can be, for example, illustrated as walking toward the avatar representing the user or walking toward a help desk (to signal to the user that the clerk is ready to provide assistance). Communication, such as voice communications, may be established between the user and the store clerk immediately, upon acceptance of a communication request by the virtual user, upon acceptance of a communication request by the store clerk, and the like. Communications may also be established between the user, the store clerk, other users, or any combination thereof.

In one example embodiment, a store clerk may be notified if a user enters a brick-and-mortar store, enters a virtual store, or both. The alert may depend on the privacy setting of the user. For example, the store clerk may only be sent a notification if the system is authorized to send the notification by the user. The alert may also be dependent on the location, the travel direction, or both of the user. For example, if the user is walking away from the store clerk (or away from the avatar representing the store clerk in the virtual environment), the store clerk may not be sent a notification. If the user is walking toward the store clerk (or toward the avatar representing the store clerk in the virtual environment), the store clerk may be sent a notification.

In one example embodiment, a user is represented by an avatar in the virtual environment. The user avatar may be anonymous (lacking features that identify the user represented by the avatar) or personal (having features that identify the user represented by the avatar). For example, the avatar may have facial features that resemble those of the user, may have a voice similar to the user's, may have a name tag that identities the corresponding user, and the like.

In one example embodiment, upon entry into a virtual mall or virtual store, a user may be provided with background music. In addition, if enabled by the user, the user will hear the conversations of other users, depending on the locations of the avatars representing the users in the virtual environment. For example, the closer together the speaking and listening avatars are located, the louder the audio volume of the conversation may be. The sensitivity (the ratio of the volume of the audio relative to the distance between the avatars) may be individually adjusted by each user. In addition, a user can click on an avatar representing another user to mute the conversation (being conducted by the user, by the other user, or both) or to request a communication channel with the user represented by the avatar. The communication channel may provide for speech communication, visual communication, and the like. A user or store clerk may also drag and drop information (such as textual documents) from, for example, a computer operated by the store clerk to a computer of the user in the virtual environment.

In one example embodiment, a visual display or audio system in the brick-and-mortar store can indicate the state of the brick-and-mortar store, the virtual store, or both. For example, a count of customers browsing a virtual mall or virtual store, a count of customers waiting for assistance in the virtual mall or virtual store, and the like may be displayed to help the store clerks manage the brick-and-mortar and virtual environments. A traffic light may also be generated and displayed. For example, a red indicator can represent that virtual users are waiting for assistance and that no clerks are providing assistance, a yellow indicator can represent that virtual users are waiting for assistance and that some clerks are currently providing assistance, a green indicator can represent that all virtual users requesting assistance are being provided assistance, and no indicator can represent that no virtual users are waiting for assistance.

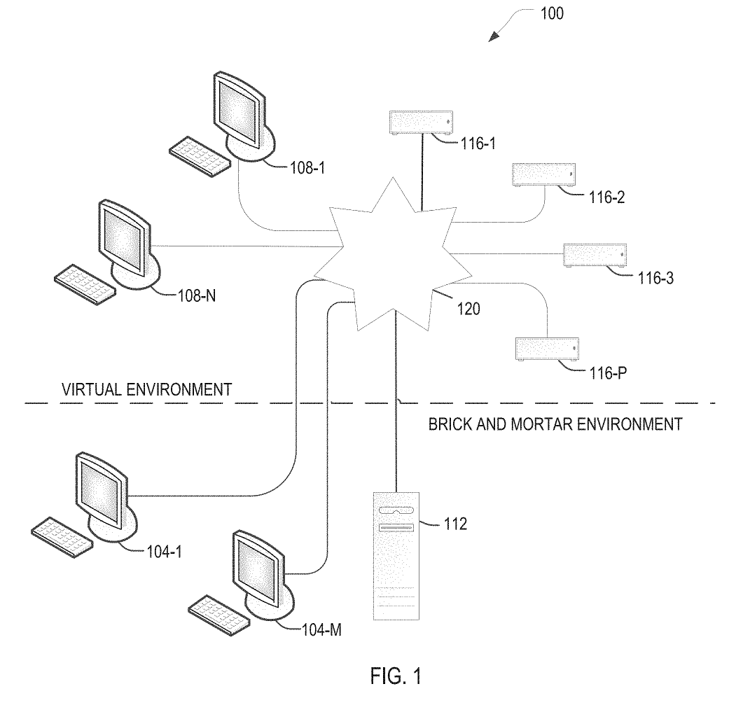

FIG. 1 is a block diagram of an example processing system 100 for providing a shopping environment, in accordance with an example embodiment. In one example embodiment, the processing system 100 comprises clerk client devices 104-1, . . . , 104-M (collectively known as clerk client devices 104 hereinafter), user client devices 108-1, . . . , 108-N (collectively known as user client devices 108 hereinafter), a brick-and-mortar (BAM) server 112, virtual environment servers 116-1, . . . , 116-P (collectively known as virtual environment servers 116 hereinafter), and a network 120.

Each clerk client device 104 and user client device 108 may be a personal computer (PC), a tablet computer, a mobile phone, a telephone, a personal digital assistant (PDA), a wearable computing device (e.g., a smartwatch), or any other appropriate computer device. The clerk client devices 104 and user client devices 108 may each include a user interface module. In one example embodiment, the user interface module may include a web browser program and/or an application, such as a mobile application, an electronic mail application, and the like. Although a detailed description is only illustrated for the clerk client device 104 and user client device 108, it is to be noted that other user devices may have corresponding elements with the same functionality.

The BAM server 112 provides, for example, services for a BAM store and the associated store clerks. For example, the BAM server 112 notifies the store clerks of the entry of a user into the BAM store or an associated virtual store, provides connectivity between the store clerks and the virtual environment, provides an indication of the state of the BAM environment and the virtual environment, and the like. The BAM server 112 also maintains the state of the user's shopping experience in the BAM environment and exchanges user shopping information with the virtual environment servers 116.

The virtual environment servers 116 generate the virtual environment and enable users to shop in the virtual environment, view items in the virtual environment, conduct transactions in the virtual environment, obtain assistance in the virtual environment, and the like. The virtual environment servers 116 maintain the state of the user's shopping activities in the virtual environment and exchange user shopping information with the BAM server 112. The virtual environment servers 116 also enable merchants to establish online stores in a virtual mall and to integrate the online stores with BAM stores.

The network 120 may be an ad hoc network, a switch, a router, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, another type of network, a network of interconnected networks, a combination of two or more such networks, and the like.

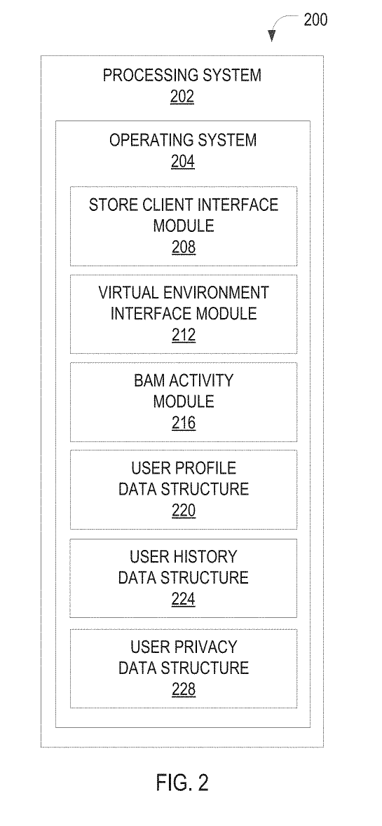

FIG. 2 is a block diagram of an example apparatus 200 for implementing a BAM server 112, in accordance with an example embodiment. The apparatus 200 is shown to include a processing system 202 that may be implemented on a client or other processing device, and that includes an operating system 204 for executing software instructions.

In accordance with an example embodiment, the apparatus 200 may include a store client interface module 208, a virtual environment interface module 212, a BAM activity module 216, a user profile data structure 220, a user history data structure 224, and a user privacy data structure 228.

The store client interface module 208 provides an interface between the BAM activity module 216 and the clerk client devices 104. The store client interface module 208 transfers data related to user activity in the virtual environment, user requests for assistance, and the like to store clerks. The virtual environment interface module 212 provides for the exchange of information with the virtual environment servers 116. For example, the virtual environment interface module 212 transfers information regarding the virtual users to the BAM activity module 216 and transfers information regarding user activities in the BAM store to the virtual environment servers 116.

The BAM activity module 216 detects the entry of users into the BAM store, retrieves information regarding the detected users from the virtual environment servers 116, tracks user activities in the BAM store, maintains an indication of the state of the BAM environment, and provides information regarding user activities in the BAM store to the virtual environment servers 116. The BAM activity module 216 maintains a queue of requests from users in the virtual environment for the assistance of the store clerks. In one example embodiment, the BAM activity module 216 provides updated user profile and user history information to the virtual environment servers 116.

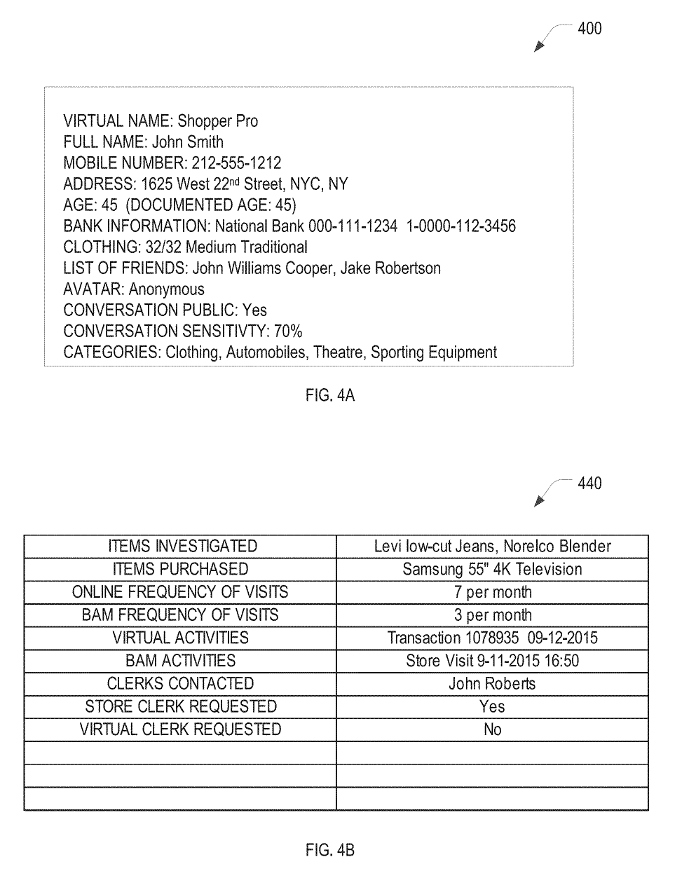

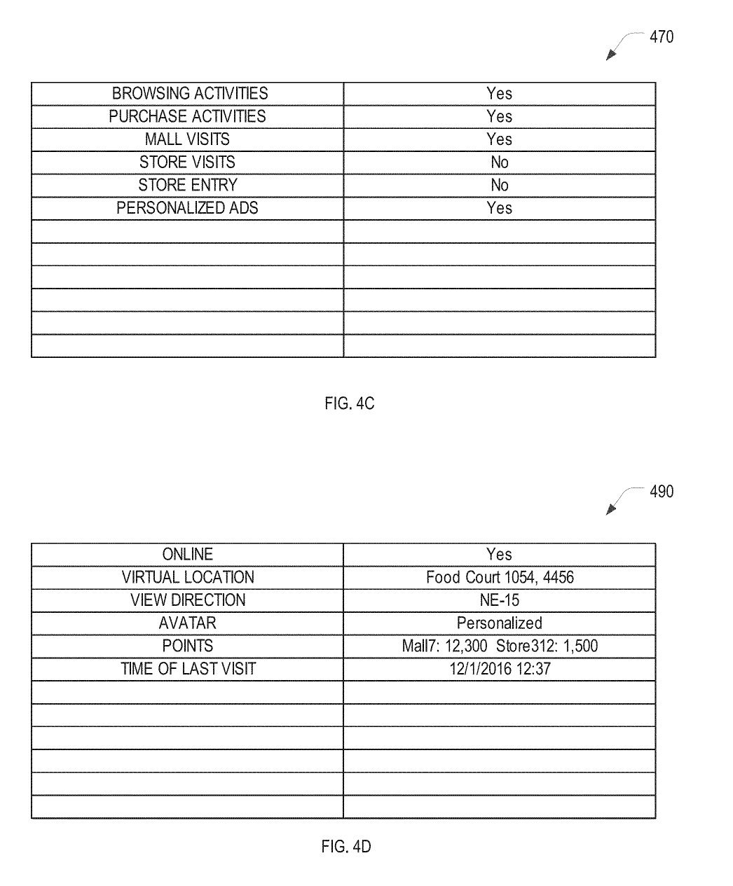

The user profile data structure 220 temporarily stores the profile data of users who are in the BAM store, as described more fully below by way of example in conjunction with FIG. 4A. In one example embodiment, the user profile data structure 220 stores the profile data of users who visited the BAM store in the past, users who executed transactions in the BAM store in the past, and the like.

The user history data structure 224 temporarily stores the historical data of users who are in the BAM store, as described more fully below by way of example in conjunction with FIG. 4B. In one example embodiment, the user history data structure 224 stores the historical data of users who visited the BAM store in the past, users who executed transactions in the BAM store in the past, and the like.

The user privacy data structure 228 temporarily stores the privacy settings of users who are in the BAM store, as described more fully below by way of example in conjunction with FIG. 4C. In one example embodiment, the user privacy data structure 228 stores the privacy settings of users who visited the BAM store in the past, users who executed transactions in the BAM store in the past, and the like.

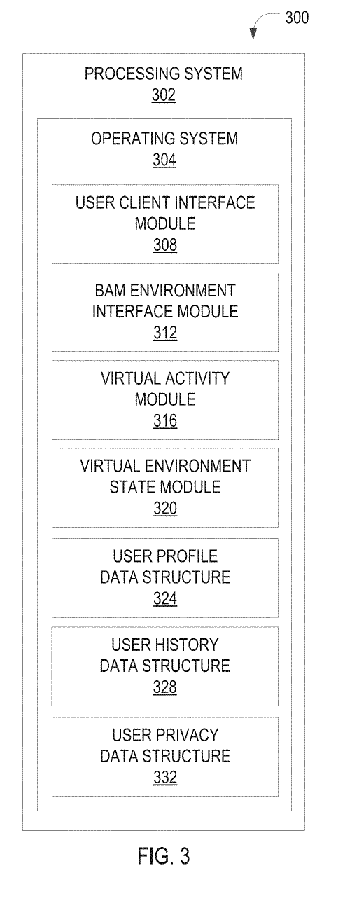

FIG. 3 is a block diagram of an example apparatus 300 for implementing the virtual environment server 116, in accordance with an example embodiment. The apparatus 300 is shown to include a processing system 302 that may be implemented on a client or other processing device, and that includes an operating system 304 fur executing software instructions.

In accordance with an example embodiment, the apparatus 300 may include a user client interface module 308, a BAM environment interface module 312, a virtual activity module 316, a virtual environment state module 320, a user profile data structure 324, a user history data structure 328, and a user privacy data structure 332.

The user client interface module 308 provides an interface between the virtual activity module 316 and the user client devices 108, and transfers data related to the generation of the virtual environment to the user client devices 108. The BAM environment interface module 312 provides for the exchange of information with the BAM server 112. For example, the BAM environment interface module 312 transfers information regarding the users in the BAM stores to the virtual activity module 316 and transfers information regarding user activities in the virtual environment to the BAM server 112.

The virtual activity module 316 instantiates an instance of the virtual environment for a virtual user, retrieves information regarding the user's BAM activities from the BAM activity module 216, tracks user activities in the virtual environment, maintains an indication of the state of the virtual environment, and provides information regarding user activities in the virtual environment to the BAM activity module 216. In one example embodiment, the virtual activity module 316 provides updated user profile and user history information to the BAM activity module 216.

The virtual environment state module 320 maintains general information regarding the state of the virtual environment, such as the location of an avatar representing the virtual user, the view direction of the avatar representing the virtual user, the state of ongoing conversations between avatars, the state of transactions being processed, and the like. The virtual environment state module 320 provides general information regarding the state of the virtual environment to the virtual activity module 316 for instantiating an instance of the virtual environment for a virtual user.

The user profile data structure 324 stores the profile data of users who are in the virtual environment, who visited the virtual environment, who executed transactions in the virtual environment, and the like, as described more fully below by way of example in conjunction with FIG. 4A. The user history data structure 328 stores the historical data of users who are in the virtual environment, who visited the virtual environment, who executed transactions in the virtual environment, and the like, as described more fully below by way of example in conjunction with FIG. 4B. The user privacy data structure 332 stores the privacy data for users who are in the virtual environment, who visited the virtual environment, who executed transactions in the virtual environment, and the like, as described more fully below by way of example in conjunction with FIG. 4C.

FIG. 4A is a table 400 for an example user profile, according to an example embodiment. Each row of the table 400 corresponds to a particular parameter of the user profile. The user profile may include a virtual name, a real (full) name, user bank account information, clothing size and style information, selected avatar style(s) and appearance(s), a list of friends, contact information (such as mobile number, landline number, residential address, and the like), reported age, documented age (for activities that, for example, have an age requirement), conversation settings (such as permission for other users to overhear the user's conversation (such as public or private), the volume of overheard conversations (such as conversation sensitivity), and the like), categories of items of interest, and the like.

FIG. 4B is a table 440 for an example shopping history of a user, according to an example embodiment. Each row of the table 440 corresponds to a particular shopping parameter. The user's history may include a list of items investigated, a list of items acquired (such as item identification, place of purchase, and the like), a user's visit frequency (such as the frequency of online visits, the frequency of BAM visits, and the like), a user's virtual activities (such as shops visited, time of visits, items purchased, transactions, and the like), a user's BAM activities (such as store visited, time of visits, transactions, and the like), a list of clerks contacted, whether a shopping concierge (such as a store clerk or virtual clerk) is requested, and the like. Some information, such as entry into a virtual mall, may be available to, for example, all store managers in the virtual mall, while other information, such as entry into a virtual store, may be available to, for example, only the manager of the corresponding store.

FIG. 4C is a table 470 for example privacy settings of a user, according to an example embodiment. The privacy settings may include whether browsing activities may be tracked, whether purchase activities may be tracked, whether mall visits may be detected and tracked, whether store visits may be detected and tracked, whether detection of the user's entry into a physical store is permitted, whether personalized advertisements are permitted, and the like. The privacy settings may also include the amount and type of information related to virtual activities that may be accessed by a store clerk (such as the identity of visited malls, the identity of visited shops, the time of visits, the identity of items viewed, the identity of items purchased, and the like) and the amount and type of information related to BAM activities that may he accessed by a store clerk (such as the identity of visited BAM shops, the time of visits, the identity of items viewed, the identity of items purchased, and the like).

FIG. 4D is an example table 490 for maintaining the state of user shopping activities, according to an example embodiment. The maintained state may include an indication of whether the user is online, the user's virtual location, the user's virtual view direction, the avatar type (such as anonymized, standard, personalized, and the like), a points status (such as a status of points awarded for mall visits, store visits, transactions, and the like), and the like.

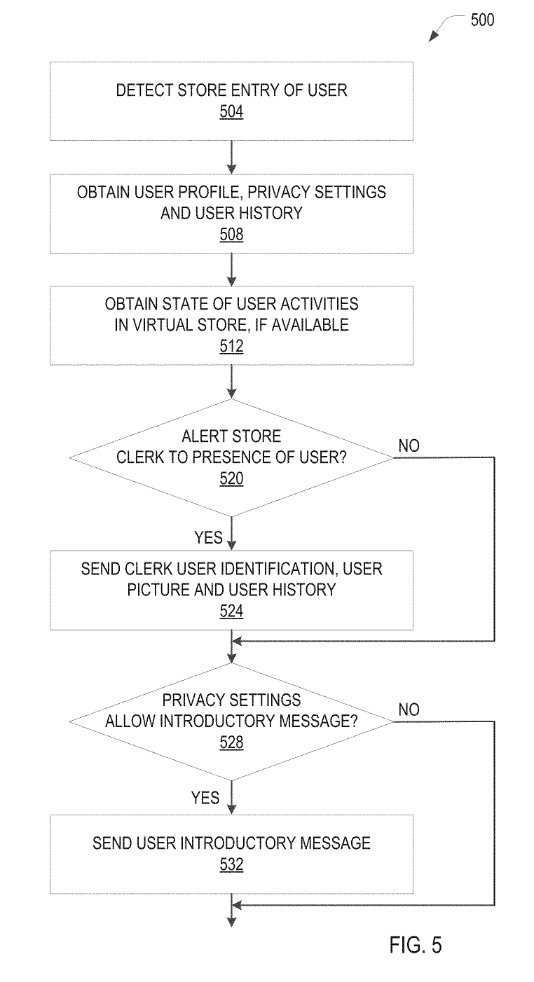

FIG. 5 is a flowchart for an example method 500 for processing a user entry into a BAM store, according to an example embodiment. In one example embodiment, the method 500 is performed by the BAM activity module 216.

In one example embodiment, if allowed by a user's privacy settings, an entry of the user into a BAM store is detected (operation 504). example, the user's entry may be detected by scanning for an RFID tag carried by the user, by performing face recognition on an image of the store's entry point, and the like. Information associated with the identified user is obtained (operation 508). For example, a user's profile, a user's privacy settings, a user's history, a customer value level, and the like may be obtained. If the user has conducted online activity, the state of the activity (such as the identity of the items viewed online, the state of in-progress or completed transactions, requests by the user for assistance or for information on an item, and the like) may also be retrieved (operation 512). In one example embodiment, the online information is only retrieved if the online activity is associated with the BAM store that the user entered. In one example embodiment, the online information is only retrieved if allowed by the user's privacy settings.

In one example embodiment, a test is performed to determine if the user's privacy settings allow a clerk to be notified of the user's entry into the BAM store (operation 520). If the user's privacy settings allow, the user's identification, the user's picture, and the user's history are forwarded to a device accessible to the store clerk (such as the clerk client device 104) (operation 524); otherwise, the method 500 proceeds to operation 528.

A test is performed to determine if the user's privacy settings allow a message to be sent to the user (operation 528). If the user's privacy setting allows a message to be sent, an introductory message is sent to the user (operation 532). For example, a text message may be sent to the user's mobile device, a message may be displayed on a store monitor, and the like. The method 500 then ends.

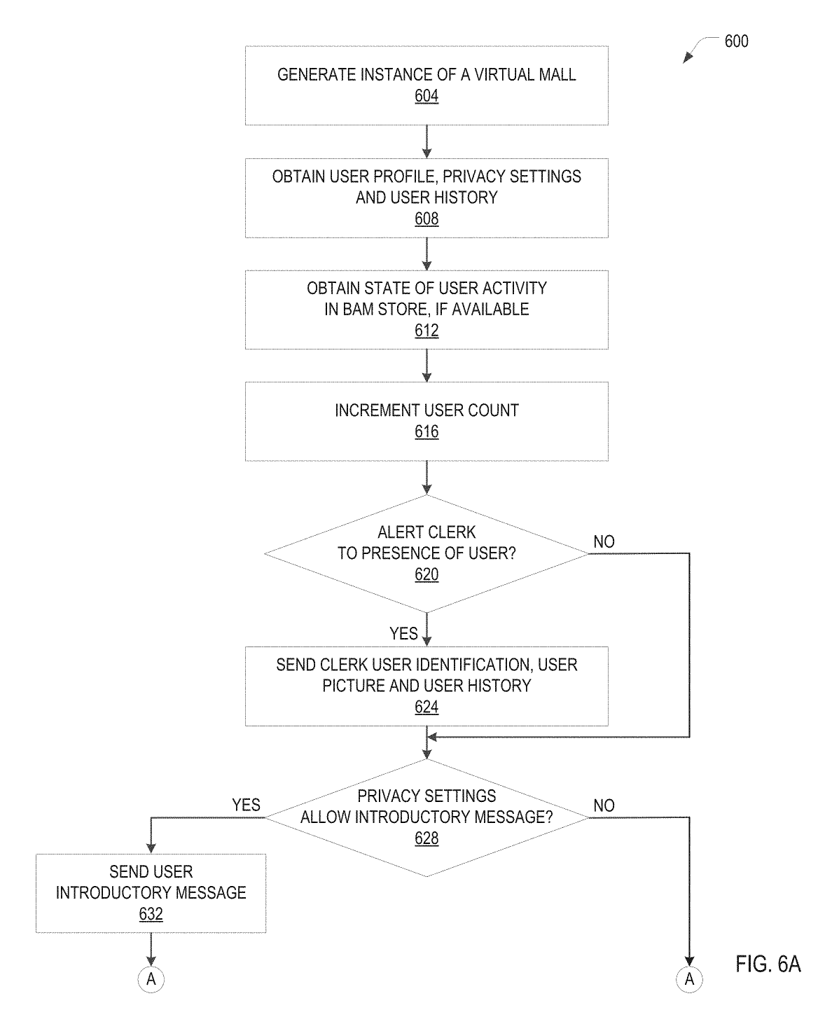

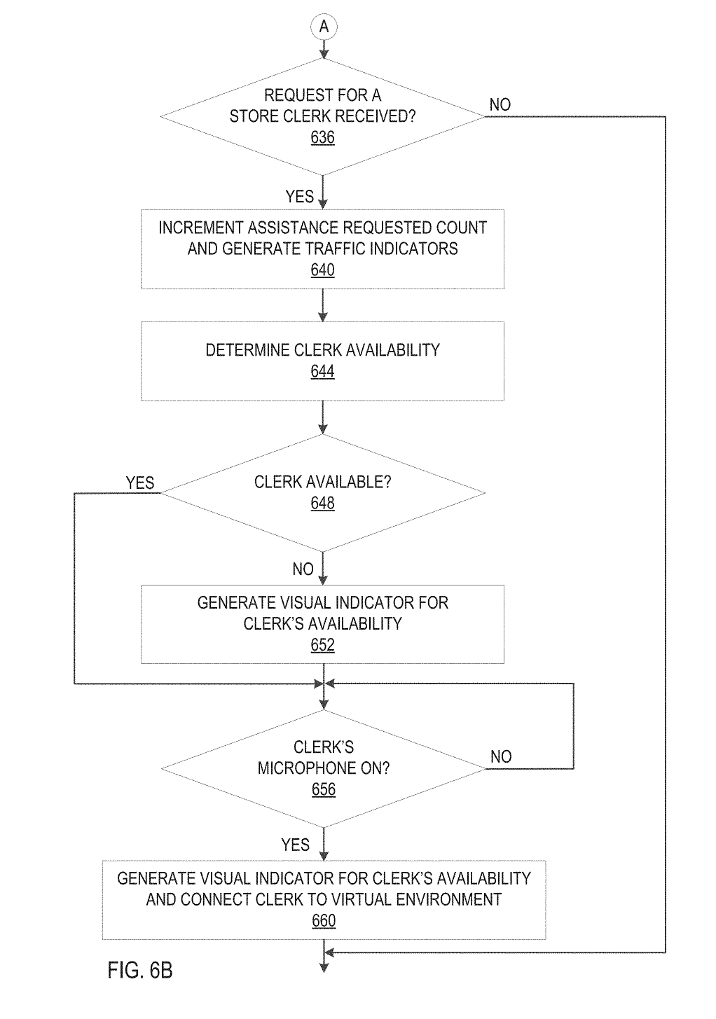

FIGS. 6A and 6B are a flowchart for an example method 600 for processing a user entry into a virtual mall or virtual store, according to an example embodiment. In one example embodiment, the method 600 is performed by the virtual activity module 316.

In one example embodiment, an instance of a virtual mall or virtual store is generated for a user (operation 604). Information associated with the user is obtained (operation 608). For example, a user's profile, a user's privacy settings, a user's shopping history, a customer value level, and the like may be obtained. If the user has visited an associated BAM store, the state of the activity (such as the identity of the items viewed in the BAM store, the state of in-progress or completed transactions, and the like) may also be retrieved (operation 612). In one example embodiment, the BAM information is only retrieved if allowed by the user's privacy settings. A count of users in the virtual mall, a count of users in the virtual store, or both is incremented (operation 616).

In one example embodiment, a test is performed to determine if the user's privacy settings allow a clerk to be notified that the user entered a virtual mall or a particular virtual store (operation 620). If the user's privacy settings allow, the user's identification, the user's picture, and the user's history are forwarded to a device accessible by the store clerk (such as the clerk client device 104) (operation 624); otherwise, the method 600 proceeds to operation 628. In one example embodiment, the notification to the store clerk is an audio message that, for example, converts the text describing the user's identification and the user's history to speech that is then played via the clerk's headphones.

In one example embodiment, a test is performed to determine if the user's privacy settings allow a message to be sent to the user (operation 628). If the user's privacy settings allow a message to be sent to the user, an introductory message, such as a text message, an audio message, and the like, is sent to the user (operation 632).

A test is performed to determine if a request for assistance of a store clerk in the virtual environment has been received from the user (operation 636). If a request for the assistance of a store clerk in the virtual environment has been not been received from the user, the method 600 ends; otherwise, an assistance requested count is incremented and traffic indicators are revised (operation 640). The request for assistance may be an explicit request, such as the user selecting an assistance icon in the virtual environment, or an implicit request, such as the avatar representing the user walking toward a virtual help desk or toward an avatar representing the store clerk. The availability of store clerks is determined, as indicated by each store clerk (operation 644). For example, a store clerk may disable a microphone to indicate that the store clerk is not available and may enable the microphone to indicate that the store clerk is available.

A test is performed to determine if a store clerk is available (operation 648). If a store clerk is available, the method 600 proceeds with operation 656; otherwise, a visual indication of the clerk's availability (not available) is generated (operation 652). For example, the avatar representing the store clerk can be illustrated as being busy interacting with another avatar, being busy at a counter, being busy in a store room, and the like.

A test is performed to determine if the store clerk's microphone is enabled (operation 656). if the store clerk's microphone is not enabled, operation 656 is repeated; otherwise, a connection is established between the store clerk and the virtual environment (operation 660). In addition, the avatar representing the store clerk can be illustrated as walking toward the avatar of the user, illustrated as walking toward a virtual desk or counter, and the like to signal to the user that the store clerk is ready to assist.

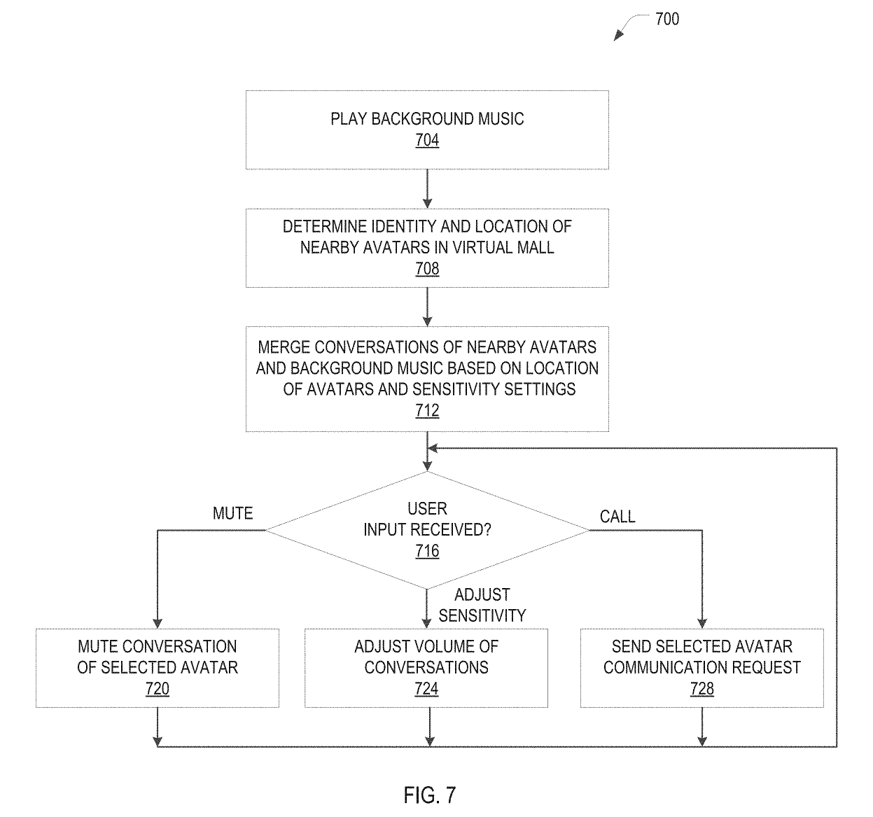

FIG. 7 is a flowchart for an example method 700 for generating audio for a user in the virtual environment, according to an example embodiment. In one example embodiment, the method 700 is performed by the virtual activity module 316.

in one example embodiment, background music is played for the user in the virtual environment (operation 704). The identity and location of avatars located near the avatar representing the user are determined (operation 708). The volume of each conversation corresponding to a nearby avatar is adjusted based on the sensitivity selected by the user and the distance between the user's avatar and the nearby avatar, and the adjusted audio is overlaid on the background music (if enabled by the user's profile and privacy settings) (operation 712).

In one example embodiment, a test is performed to determine if user input has been received (operation 716). If no input is received, operation 716 is repeated (not shown). If an avatar has been selected for muting, the conversation associated with the selected avatar is identified and the associated conversation is withdrawn from the audio merge conducted in operation 712. If the audio sensitivity has been adjusted, the volume of each conversation corresponding to a nearby avatar is adjusted based on the sensitivity and the distance between the user's avatar and the nearby avatar (operation 724). If the user selected an avatar representing another user with whom to initiate a conversation, a communication request is sent to the user corresponding to the selected avatar (operation 728). The method 700 then proceeds to operation 716.

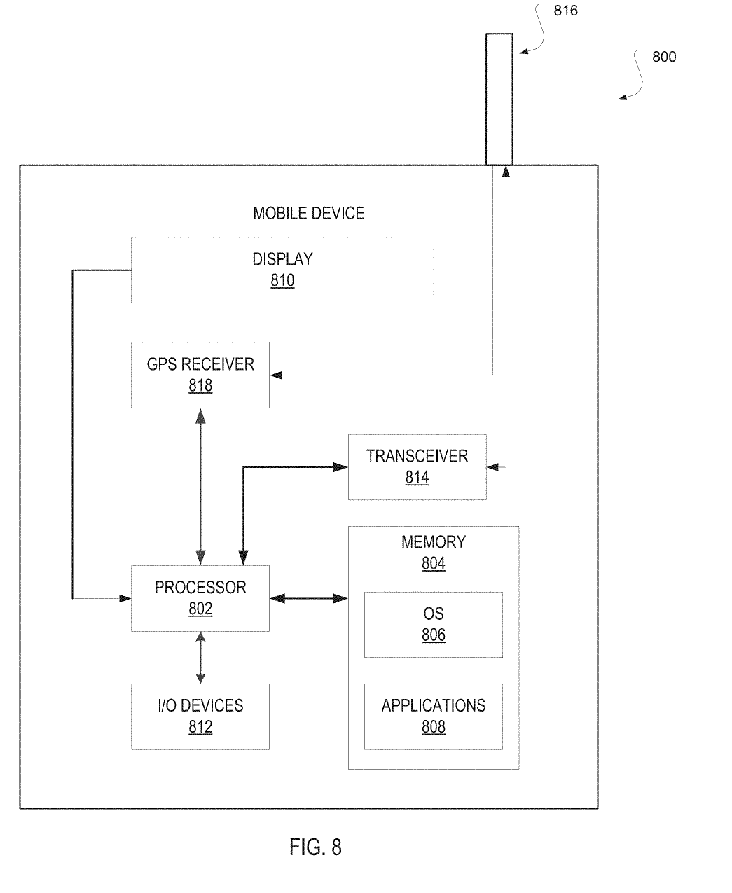

FIG. 8 is a block diagram illustrating a mobile device 800, according to an example embodiment. The mobile device 800 can include a processor 802. The processor 802 can be any of a variety of different types of commercially available processors suitable for mobile devices 800 (for example, an XScale architecture microprocessor, a microprocessor without interlocked pipeline stages (MIPS) architecture processor, or another type of processor). A memory 804, such as a random access memory (RAM), a flash memory, or another type of memory, is typically accessible to the processor 802. The memory 804 can be adapted to store an operating system (OS) 806, as well as applications 808, such as a mobile location-enabled application that can provide location-based services (LBSs) to a user. The processor 802 can be coupled, either directly or via appropriate intermediary hardware, to a display 810 and to one or more input/output (I/O) devices 812, such as a keypad, a touch panel sensor, and a microphone. Similarly, in some embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a global positioning system (GPS) receiver 818 can also make use of the antenna 816 to receive GPS signals.

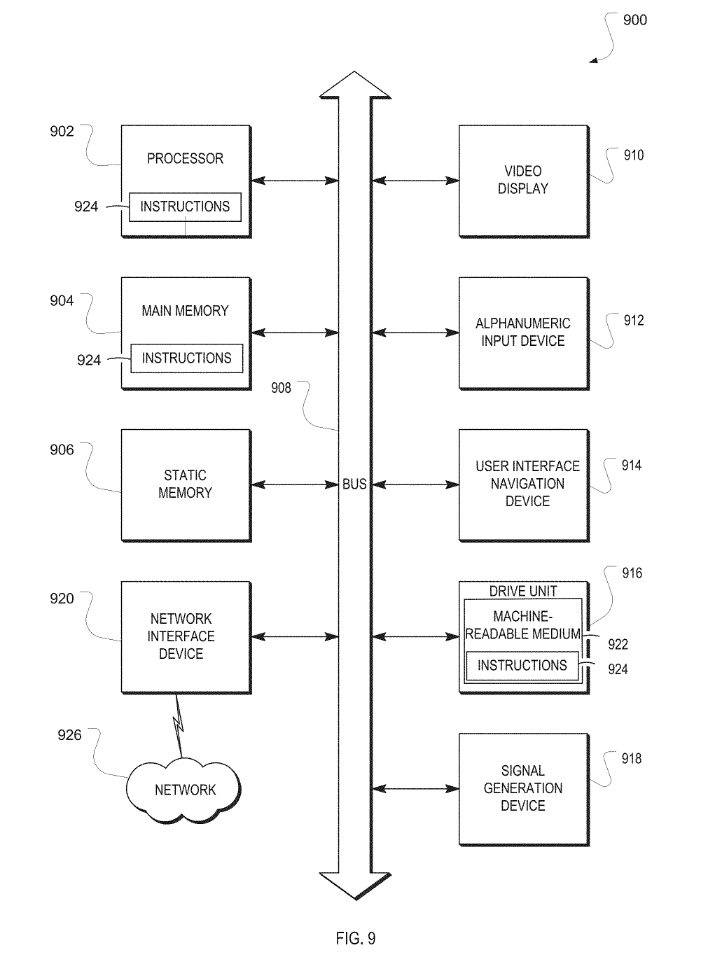

FIG. 9 is a block diagram of a computer processing system 900 within which a set of instructions 924 may be executed for causing a computer to perform any one or more of the methodologies discussed herein. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed as software-as-a-service (SaaS), by an application service provider (ASP), or by utility computing providers. The computer may be a server computer, a PC, a tablet PC, a PDA, a cellular telephone, or any processing device capable of executing a set of instructions 924 (sequential or otherwise) that specify actions to be taken by that device. Further, while only a single computer is illustrated, the term “computer” shall also be taken to include any collection of computers that, individually or jointly, execute a set (or multiple sets) of instructions 924 to perform any one or more of the methodologies discussed herein.

The example computer processing system 900 includes a processor 902 (e.g., a central processing unit (CPU), a graphics processing unit (GPU), or both), a main memory 904, and a static memory 906, which communicate with each other via a bus 908. The computer processing system 900 may further include a video display 910 (e.g., a plasma display, a liquid crystal display (LCD), or a cathode ray tube (CRT)). The computer processing system 900 also includes an alphanumeric input device 912 (e.g., a keyboard), a user interface navigation device 914 (e.g., a mouse and/or touch screen), a drive unit 916, a signal generation device 918 (e.g., a speaker), and a network interface device 920.

The drive unit 916 includes a machine-readable medium 922 on which is stored one or more sets of instructions 924 and data structures embodying or utilized by any one or more of the methodologies or functions described herein. The instructions 924 may also reside, completely or at least partially, within the main memory 904, the static memory 906, and/or the processor 902 during execution thereof by the computer processing system 900, the main memory 904, the static memory 906, and the processor 902 also constituting tangible machine-readable media 922.

The instructions 924 may further be transmitted or received over a network 926 via the network interface device 920 utilizing any one of a number of well-known transfer protocols (e.g., Hypertext Transfer Protocol (HTTP)).

While the machine-readable medium 922 is shown, in an example embodiment, to be a single medium, the term “machine-readable medium” should be taken to include a single medium or multiple media (e.g., a centralized or distributed database, and/or associated caches and servers) that store the one or more sets of instructions 924. The term “machine-readable medium” shall also be taken to include any medium that is capable of storing, encoding, or carrying a set of instructions 924 for execution by the computer and that cause the computer to perform any one or more of the methodologies of the present application, or that is capable of storing, encoding, or carrying data structures utilized by or associated with such a set of instructions 924. The term “machine-readable medium” shall accordingly be taken to include, but not be limited to, solid-state memories and optical and magnetic media.

While the embodiments of the invention(s) is (are) described with reference to various implementations and exploitations, it will be understood that these embodiments are illustrative and that the scope of the invention(s) is not limited to them. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method, the method comprising:
detecting, using a hardware based detection system, an entry of a user into a physical establishment;
retrieving information corresponding to a virtual activity of the user in a virtual environment in response to detecting the entry of the user into the physical establishment; and
providing the information to a client device corresponding to the physical establishment.

2. The method of claim 1, the method further comprising generating an indication of a status of one or more requests for assistance in the virtual environment.

3. The method of claim 2, wherein the indication indicates a count of users waiting for assistance in the virtual environment.

4. The method of claim 2, wherein a first indicator represents that one or more virtual users are waiting for assistance and that none of the one or more virtual users that are waiting for assistance are receiving assistance, a second indicator represents that at least one virtual user is waiting for assistance and that at least one store clerk is providing assistance, a third indicator represents that all virtual users requesting assistance are being provided assistance, and an absence of an indicator represents that no virtual users are waiting for assistance.

5. A computerized method, the method comprising:
instantiating, using at least one hardware processor, an instance of a virtual environment for a user;
retrieving, using the at least one hardware processor, information corresponding to one or more activities of the user in a physical shopping environment; and
integrating, using the at least one hardware processor, the retrieved information with information of the virtual environment.

6. The method of claim 5, the method further comprising:
tracking an availability of a store clerk in a physical establishment of the physical shopping environment; and
indicating, in the virtual environment, the availability of the store clerk by a configuration of an avatar representing the store clerk.

7. The method of claim 6, the method further comprising:
receiving a request in the virtual environment for assistance; and
notifying the store clerk in the physical establishment of the request for assistance.

8. The method of claim 7, the method further comprising connecting the store clerk to the virtual environment in response to the store clerk indicating a readiness to provide the requested assistance.

9. The method of claim 5, wherein an amount of the information retrieved is based on a privacy setting of the user.

10. The method of claim 5, the method further comprising:
merging a conversation of another user with background music to create merged audio, the other user being represented by an avatar within a predefined distance of an avatar representing the user; and
presenting the merged audio to the user.

11. The method of claim 10, wherein a volume of the conversation is adjusted based on a distance between an avatar representing a second user who is speaking and the avatar representing the user.

12. An apparatus comprising:
one or more hardware processors;
memory to store instructions that, when executed by the one or more hardware processors perform operations comprising:
instantiating an instance of a virtual environment for a user;
retrieving information corresponding to one or more activities of the user in a physical shopping environment; and
integrating the retrieved information with information of the virtual environment.

13. The apparatus of claim 12, the operations further comprising:
tracking an availability of a store clerk in a physical establishment of the physical shopping environment; and
indicating, in the virtual environment, the availability of the store clerk by a configuration of an avatar representing the store clerk.

14. The apparatus of claim 13, the operations further comprising:
receiving a request in the virtual environment for assistance; and
notifying the store clerk in the physical establishment of the request for assistance.

15. The apparatus of claim 12, wherein an amount of the information retrieved is based on a privacy setting of the user.

16. The apparatus of claim 12, the operations further comprising:
merging a conversation of another user with background music to create merged audio, the other user being represented by an avatar within a predefined distance of an avatar representing the user; and
presenting the merged audio to the user.

17. The apparatus of claim 16, wherein a volume of the conversation is adjusted based on a distance between an avatar representing a second user who is speaking and the avatar representing the user.

18. The apparatus of claim 12, the operations further comprising generating an indication of a status of one or more requests for assistance in the virtual environment.

19. The apparatus of claim 18, wherein the indication indicates a count of users waiting for assistance in the virtual environment.

20. A non-transitory machine-readable storage medium comprising instructions, which when implemented by one or more machines, cause the one or more machines to perform operations comprising:
instantiating an instance of a virtual environment for a user;
retrieving information corresponding to one or more activities of the user in a physical shopping environment; and
integrating the retrieved information with information of the virtual environment.
